(19) United States
(12) Patent Application Publication
(10) Pub. No.: US 2011/0012517 A1
(43) Pub. Date: Jan. 20, 2011

(54) ORGANIC ELECTROLUMINESCENT DEVICE

(75) Inventor: Shuichi Seki, Yamagata (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: PIONEER CORPORATION, Tokyo (JP); TOHOKU PIONEER CORPORATION, Tendo-shi, Yamagata (JP)

(21) Appl. No.: 12/922,960

(22) PCT Filed: Mar. 31, 2008
(86) PCT No.: PCT/JP2008/056302

§ 371 Date: Sep. 16, 2010

(51) Int. Cl. H05B 37/02

(52) U.S. Cl. 315/158

(57) ABSTRACT

The present invention provides a display device which includes photoelectric elements (E1 to E4) outputting an electromotive force according to an illuminance of external light, a self-luminous display panel (1) disposed with at least one self-luminous element, and drive circuits (2a, 3a) for driving and controlling the self-luminous display panel.

The display device is configured such that a logic circuit of the drive circuit receives a supply as a drive power supply to the logic circuit through a voltage stabilization circuit (4) limiting an output voltage value from the photoelectric element, and, at the same time, the self-luminous element receives a supply as the drive power supply to the self-luminous element from the photoelectric element not through the voltage stabilization circuit.

According to the above constitution, the self-luminous element emits light at a brightness corresponding to the illuminance of external light, and the display panel (1) exercises a dimmer function that an emission brightness changes according to the illuminance of external light.

### TECHNICAL FIELD

The present invention relates to a display device which can be suitably mounted in an apparatus, in which it is impossible or difficult to include a battery, such as a thin portable apparatus.

### BACKGROUND ART

With recent high-density integration of electronic circuit components and development of high-density mounting technology, a wide variety of portable apparatuses are provided. These portable apparatuses should be provided with a display device for displaying information.

Meanwhile, the above-mentioned portable apparatus including a display device is required to further increase the functions as well as reduce weight and thickness. When all is said, focusing on a battery relatively increased in volume and weight, there is being proposed a portable apparatus without using the battery. Thus, it is considered that a so-called solar battery cell which can be reduced in weight and thickness is used as a drive power supply of the above-mentioned portable apparatus including a display device.

The driving of a display panel using the solar battery cell has been conventionally applied to a small calculator. This is disclosed in the following Patent Document 1, for example.

Patent Document 1: Japanese Patent Application Publication No. 2-28153

According to the calculator disclosed in Patent Document 1, it is disclosed that when an output voltage of a solar battery cell is reduced lower than a reference value, supply of a power supply voltage to an arithmetic circuit is stopped, whereby a wrong calculation result is prevented from being displayed.

Further, as others for driving the display panel utilizing the solar battery cell, there have been proposed ones disclosed in Patent Documents 2 and 3.

### Patent Document 2: Japanese Utility Model Application Laid-Open No. 1-68958

### Patent Document 3: Japanese Patent Application Publication No. 7-99453

According to the constitutions disclosed in Patent Documents 2 and 3, a rechargeable battery is mounted separately from the solar battery cell, and energy generated by the solar battery cell is stored in the rechargeable battery, and the power supply voltage of the rechargeable battery is utilized as the drive power supply. In short, by virtue of the use of the rechargeable battery, it is to prevent influences of voltage fluctuation corresponding to an amount of external light specific to the solar battery cell.

### DISCLOSURE OF THE INVENTION

### Problems to be Solved by the Invention

As described above, the apparatuses disclosed in Patent Documents 1 to 3 all focus on the prevention of the influences of the voltage fluctuation corresponding to the amount of external light specific to the solar battery cell. To this end, for example, detecting means for detecting the output voltage of the solar battery cell and a rechargeable battery are used in combination.

An object of the invention is to provide a display device, which is configured such that when a display panel is driven to emit light utilizing a solar battery cell, the action of a voltage fluctuation of the solar battery cell corresponding to external light is positively used to make a self-luminous display panel exercise a dimmer function, and, at the same time, a drive circuit for driving and controlling the self-luminous display panel is stably driven and operated.

### Means for Solving the Problems

A display device according to the invention which has been made in order to solve the above problems, according to claim 1, includes a photoelectric element outputting an electromotive force according to an illuminance of external light, a light-emitting device disposed with at least one self-luminous element, and a drive circuit for driving and controlling the light-emitting device. The display device is configured such that a logic circuit of the drive circuit receives a supply as a drive power supply to the logic circuit through a voltage stabilization circuit limiting an output voltage value from the photoelectric element, and, at the same time, the self-luminous element receives a supply as the drive power supply to the self-luminous element from the photoelectric element not through the voltage stabilization circuit, and the self-luminous element emits light at a brightness corresponding to the illuminance of external light.

### BRIEF DESCRIPTION OF THE DRAWINGS

FIG. 1 is a circuit configuration diagram showing a first embodiment of a display device according to the invention.

FIG. 2 is a circuit configuration diagram showing a second embodiment according to the invention.

FIG. 3 is a circuit configuration diagram showing a third embodiment according to the invention.

FIG. 4 is a circuit configuration diagram showing a fourth embodiment according to the invention.

### EXPLANATION OF REFERENCE SYMBOLS

1 self-luminous display panel (light-emitting device)
2 data driver
2a drive circuit A
3 scan driver
3a drive circuit B
4 voltage stabilization circuit
5 booster circuit
E1 to E4 photoelectric element (solar battery cell)
m1 to m3 data line (anode line)
n1 to n4 scan line (cathode line)

### BEST MODE FOR CARRYING OUT THE INVENTION

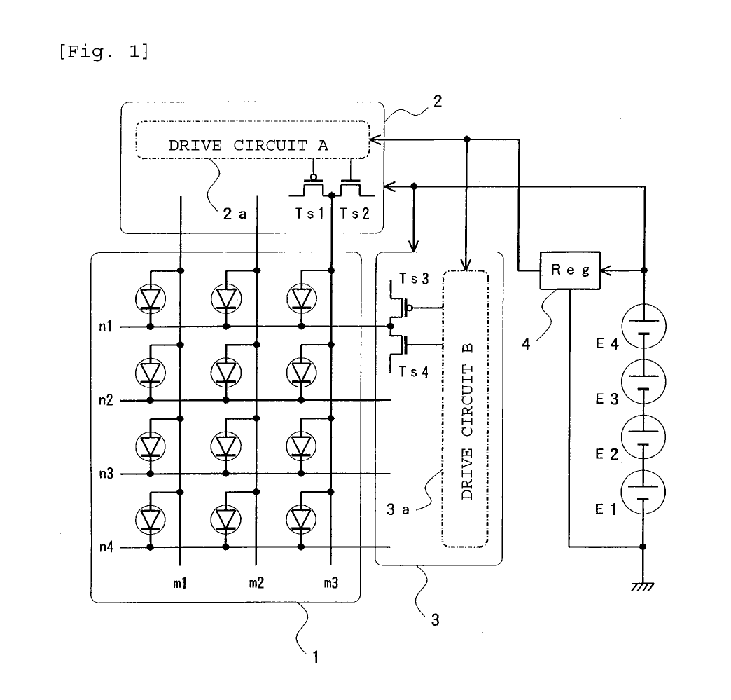

Hereinafter, a display device according to the invention will be described based on embodiments shown in the drawings. FIG. 1 shows a first embodiment of the display device. In the first embodiment, a light-emitting display panel 1 is used as a light-emitting device, and a passive matrix type display panel using an organic EL element as a self-luminous element mounted on the light-emitting display panel is configured.

In the display panel 1, at each intersection position between a plurality of data lines (hereinafter also referred to as anode lines) m1 to m3 arranged in the longitudinal direction and a plurality of scan lines (hereinafter also referred to as cathode lines) n1 to n4 arranged in the lateral direction, organic EL elements represented by diode marks are each connected between the data line and the scan line. According to this constitution, the organic EL elements constituting pixels are arranged in the form of a matrix.

FIG. 1 shows the pixels, constituted of the organic EL elements, of four rows by three columns in the longitudinal and lateral directions because of space limitations; however, a large number of elements are arranged in the form of a matrix in the longitudinal and lateral directions over the entire display panel 1.

Reference numeral 2 represents a data driver selectively applying a drive current to the anode lines m1 to m3 of the display panel 1. Although the illustration is partially omitted, the anode lines are each connected to a pair of switching elements TS1 and TS2 alternatively supplying a turned-on drive potential of an EL element or a turned-off potential (for example, a ground potential) to the anode lines.

Further, there is mounted on the data driver 2 a drive circuit A denoted by reference numeral 2a and including a logic circuit including a shift register controlling on and off of the switching elements TS1 and TS2, corresponding to the anode lines, based on image data.

Reference numeral 3 represents a scan driver selectively scanning the cathode lines n1 to n4 of the display panel 1. Although the illustration is partially omitted, the cathode lines are each connected to a pair of switching elements TS3 and TS4 applying a scanning potential (for example, a ground potential) or a reverse bias potential to the cathode lines.

Further, there is mounted on the scan driver 3 a drive circuit B denoted by reference numeral 3a and including a logic circuit including a shift register controlling on and off of the switching elements TS3 and TS4, corresponding to the cathode lines, based on a scan synchronous signal of image data.

Meanwhile, reference numerals E1 to E4 represent photoelectric elements supplying a drive power to the display panel 1 through the data driver 2 and the scan driver 3, and they are constituted of a series connection body including solar battery cells.

In the embodiment shown in FIG. 1, it is configured such that a DC output from the series connection body of the solar battery cells denoted as E1 to E4 is supplied to a voltage stabilization circuit 4 limiting an output voltage value. It is configured such that the output passing through the voltage stabilization circuit 4 is supplied as a drive power supply to the drive circuit A in the data driver 2 and the drive circuit B in the scan driver 3 each including the logic circuit.

The drive circuits A and B including the logic circuit have a voltage specification of 3.3 V system, for example, and the voltage stabilization circuit 4 is operated so as to convert the DC output generated by the solar battery cells E1 to E4 to the stabilized voltage value of around 3.3 V and supply the converted DC output to the drive circuits A and B.

According to the above constitution, even if the output from the solar battery cells E1 to E4 fluctuates due to external light, by virtue of the control operation of the output voltage by the voltage stabilization circuit 4, a stable operation is secured in the drive circuits A and B in the data driver 2 and the scan driver 3.

When the output voltage from the solar battery cells E1 to E4 is reduced and the output voltage of the voltage stabilization circuit 4 is not stably controlled (the output voltage of the voltage stabilization circuit 4 is reduced to such a voltage value that causes the logic circuit to be inoperable), it is preferably configured to stop (shut off) the output from the voltage stabilization circuit 4.

Meanwhile, the embodiment shown in FIG. 1 has a constitution in which the output from the solar battery cells E1 to E4 is utilized as the drive power supply of the organic EL element not through the voltage stabilization circuit 4. Namely, the output from the solar battery cell is supplied to any one of the switching elements TS1 and TS2 in the data driver 2 and the organic EL elements in a scanning state through the anode line.

The output from the solar battery cell is supplied as a reverse bias voltage to any one of the switching elements TS3 and TS4 in the scan driver 3 and the organic EL elements through the cathode lines which are not scanned and selected. According to this constitution, crosstalk emission occurring in a passive matrix type display panel is prevented.

As is well known, the above organic EL element as a self-luminous element has a characteristic that the emission brightness changes according to the anode voltage. Thus, according to the constitution in which the output from the solar battery cell is utilized as the drive power supply, the emission brightness of the organic EL element similarly changes according to the magnitude of external light received by the solar battery cell. Namely, a dimmer control in which the entire brightness of the display panel 1 changes according to external light is performed.

Thus, since the display panel 1 is subjected to the dimmer control according to external light, the visibility can be enhanced. In the data driver 2 and the scan driver 3 driving the display panel 1, a stable operation is secured as long as the output voltage value in the voltage stabilization circuit 4 is controlled within a predetermined value.

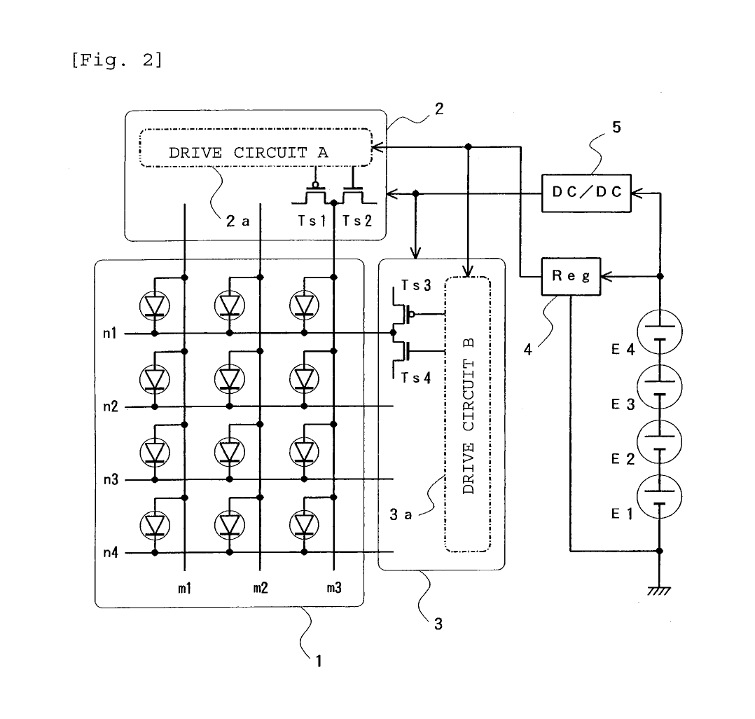

FIG. 2 shows a second embodiment of the display device according to the invention. In FIG. 2, the components equivalent to the components shown in FIG. 1 are denoted by the same reference numerals. Thus, the detailed description thereof will be omitted.

This embodiment is configured such that the output of the solar battery cells E1 to E4 as the photoelectric elements is supplied as the drive power supply to the organic EL elements, arranged on the display panel 1, through a booster circuit (DC-DC converter) denoted by reference numeral 5.

In this embodiment, as the booster circuit 5, a charge pump can be preferably used, for example. However, a booster circuit using electromagnetic conversion means using a coil can also be utilized depending on an applicable apparatus.

According to the second embodiment, even in a state that an electromotive force from the solar battery cells E1 to E4 is insufficient, the display panel 1 can be driven to emit light. By virtue of the use of the charge pump or the like as the booster circuit 5, the display panel 1 is subjected to the dimmer control according to external light, and therefore, the operational effects similar to those of the first embodiment shown in FIG. 1 can be obtained, such as the enhancement of the visibility.

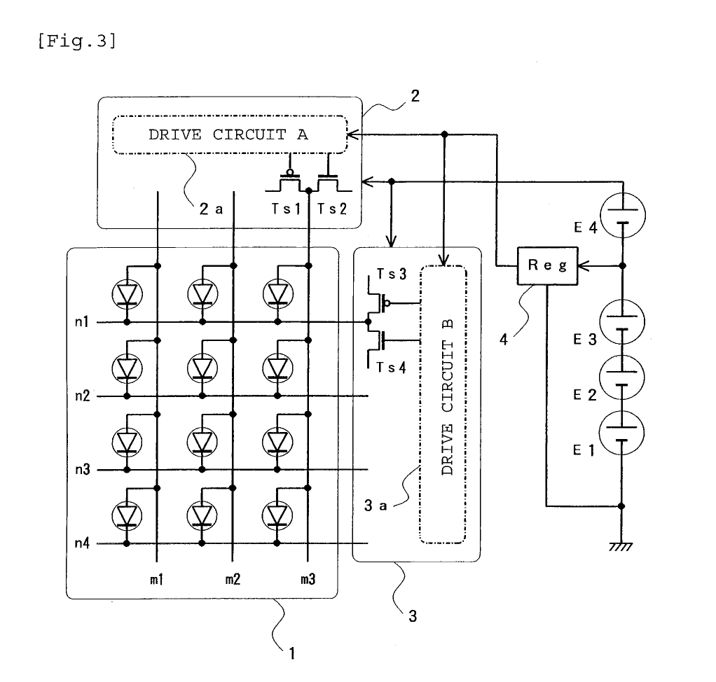

FIG. 3 shows a third embodiment of the display device according to the invention. Also in FIG. 3, the components equivalent to the components shown in FIG. 1 are denoted by the same reference numerals. Thus, the detailed description thereof will be omitted.

This embodiment is configured such that a part of the solar battery cells E1 to E4 which is a series connection body as a photoelectric element, that is, the output of the solar battery cells E1 to E3 is supplied to the voltage stabilization circuit 4, and the voltage stabilization circuit 4 supplies the output as the drive power supply to the drive circuits A and B denoted by reference numerals 2a and 3a.

Further, it is configured such that the output of the solar battery cells E1 to E4 as the series connection body is supplied as the drive power supply to the organic EL element as the self-luminous element in the display panel 1.

According to the above constitution, when a rated voltage is applied to the drive circuits A and B including the logic circuit driven by a relatively low voltage, the voltage can be reduced by the amount of voltage drop in the voltage stabilization circuit 4, and therefore, the utilization efficiency of electric power from the solar battery cell can be increased. Also in the embodiment shown in FIG. 3, the operational effects similar to those of the first embodiment shown in FIG. 1 can be obtained.

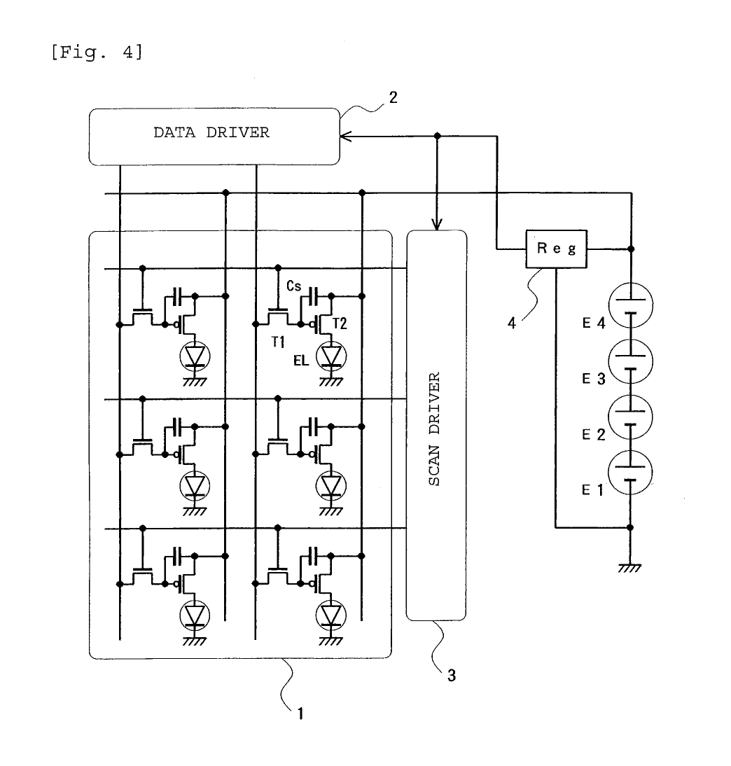

Next, FIG. 4 shows a fourth embodiment of the display device according to the invention, and in an example shown in FIG. 4, an active matrix type display panel 1 using the organic EL element as the self-luminous element is configured. Also in FIG. 4, the components equivalent to the components shown in FIG. 1 are denoted by the same reference numerals. Thus, the detailed description thereof will be appropriately omitted.

In the display panel 1 of FIG. 4, the most basic pixel circuits constituting one pixel are shown. Although the pixel circuits of three rows by two columns are shown because of space limitations, a large number of pixel circuits are arranged in the form of a matrix in the longitudinal and lateral directions over the entire display panel 1.

In FIG. 4, as one pixel circuit is denoted by reference numerals, each pixel circuit is constituted of a data write transistor T1, a drive transistor T2, a charge retention capacitor Cs, and an organic EL element EL. It is configured such that a data signal corresponding to a video signal is supplied from the data driver 2 to a source of the data write transistor T1. Further, it is configured such that a write pulse is supplied from the scan driver 3 to a gate of the data write transistor T1.

A drain of the data write transistor T1 is connected to a gate of the drive transistor T2, and, at the same time, connected to one terminal of the charge retention capacitor Cs. It is configured such that a source of the drive transistor T2 is connected to the other terminal of the capacitor Cs, and the output of the solar battery cells E1 to E4 is supplied as the drive power supply to the source of the drive transistor T2.

Meanwhile, a drain of the drive transistor T2 is connected to an anode terminal of the organic EL element EL as the self-luminous element, and a cathode terminal of the organic EL element EL is connected to a reference potential point (ground) of the display panel 1.

Meanwhile, in the embodiment shown in FIG. 4, it is configured such that a DC output from the solar battery cells as photoelectric elements denoted as E1 to E4 is supplied as the drive power supply to the data driver 2 and the scan driver 3 through the voltage stabilization circuit (regulator) 4 limiting an output voltage value.

According to the above constitution, even if the output from the solar battery cells E1 to E4 fluctuates due to external light, in the data driver 2 and the scan driver 3, the stable operation is secured as long as a voltage is controlled by the voltage stabilization circuit 4 within a predetermined value.

The pixel circuit as a light emitting object in the display panel 1 receives the supply of the DC output from the solar battery cells E1 to E4. In this case, as described above, since each pixel circuit constitutes a series circuit between the drive transistor T2 and the organic EL element EL, the emission brightness of the organic EL element constituting the pixel circuit similarly changes according to the magnitude of external light received by the solar battery cell. Namely, such a dimmer control that the entire brightness of the display panel 1 changes according to external light is performed.

Thus, in the display device using the active matrix type display panel shown in FIG. 4, the operational effects similar to those of the example using the passive matrix type display panel shown in FIGS. 1 to 3 can be obtained.

Although the display device using the active matrix type display panel is only described in the example of FIG. 4, it is natural that the embodiment shown in FIG. 2 or 3 can be applied by using the active matrix type display panel.

As described above, according to the described display device, the organic EL element constituted by stacking a thin film layer as a display panel is adopted, for example, and the solar battery cell is combined therewith as the photoelectric element supplying the drive power supply, whereby a lightweight and thin display device including a drive power source can be provided.

1. An organic electroluminescent device comprising:
a photoelectric element outputting an electromotive force according to an illuminance of external light;
a light-emitting device disposed with at least one self-luminous element; and
a drive circuit for driving and controlling the light-emitting device,
wherein the organic electroluminescent device is configured such that at least a part of a logic circuit of the drive circuit receives a supply of an output voltage from the photoelectric as a drive power supply to the logic circuit through a voltage stabilization circuit limiting an output voltage value from the photoelectric element, and, at the same time, the self-luminous element receives a supply of an output voltage from the photoelectric as the drive power supply to the self-luminous element not through the voltage stabilization circuit, and the self-luminous element emits light at a brightness corresponding to the illuminance of external light.

2. The organic electroluminescent device according to claim 1, which is configured such that the output of the photoelectric element is supplied as the drive power supply to the self-luminous element through a booster circuit DC-DC converter.

3. The organic electroluminescent device according to claim 1 or 2, which is configured such that the photoelectric element is constituted of a series connection body of unit elements each serving for converting photoelectrically, and an output from some unit elements of the series connection body is supplied as the drive power supply to the logic circuit through the voltage stabilization circuit.

4. The organic electroluminescent device according to claim 1 or 2, which is configured such that the light-emitting device is a passive matrix type light-emitting display penal comprising a self-luminous element at each intersection position between a plurality of anode lines and a plurality of cathode lines intersecting with each other, and the output of the photoelectric element is selectively supplied as the drive power supply to the self-luminous element to the anode line on the passive matrix type light-emitting display penal.

5. The organic electroluminescent device according to claim 3, which is configured such that the light-emitting device is a passive matrix type light-emitting display penal comprising a self-luminous element at each intersection position between a plurality of anode lines and a plurality of cathode lines intersecting with each other, and the output of the photoelectric element is selectively supplied as the drive power supply to the self-luminous element to the anode line on the passive matrix type light-emitting display penal.

6. The organic electroluminescent device according to claim 4, which is configured such that the output of the photoelectric element is selectively supplied as a reverse bias power supply to the cathode line on the passive matrix type light-emitting display penal.

7. The organic electroluminescent device according to claim 5, which is configured such that the output of the photoelectric element is selectively supplied as a reverse bias power supply to the cathode line on the passive matrix type light-emitting display penal.

8. The organic electroluminescent device according to claim 1 or 2, which is configured such that the light-emitting device is an active matrix type light-emitting display penal comprising a pixel including a self-luminous element and an active element at each intersection position between a plurality of data lines and a plurality of scan lines intersecting with each other, and the output of the photoelectric element is supplied as the drive power supply to the self-luminous element to each series circuit between the self-luminous element and the active element constituting the pixel.

9. The organic electroluminescent device according to claim 1 or 2, wherein the photoelectric element is a solar battery cell.

10. The organic electroluminescent device according to claim 4, wherein the photoelectric element is a solar battery cell.
